(19) United States
(12) Patent Application Publication
(10) Pub. No.: US 2005/0188778 A1
(43) Pub. Date: Sep. 1, 2005

(54) Synchronized mechanical continuously variable transmission

(76) Inventor: James Gerald Nugent, Alexandria, VA (US)

Correspondence Address: James G. Nugent, 8419 Blakiston Lane, Alexandria, VA, 22308-2105, US

(21) Appl. No.: 10/788,314

(22) Filed: Mar. 1, 2004

(51) Int. Cl. F16H 35/02; F16H 21/12

(52) U.S. Cl. 74/63

(57) ABSTRACT

A synchronized mechanical continuously variable transmission using exponential roller gears and exponential cam gears on three centers of rotation, two fixed and one translating, the placement of the translating center of rotation determining the ratio, with band clutches controlled by a telescoping internal cam used to combine the power paths.

### CROSS-REFERENCE TO RELATED APPLICATIONS

This application uses the variable gear assembly disclosed in my U.S. Pat. No. 6,212,967, granted 2002 Apr. 10. This application uses the synchronized mechanical power combiner of my co-pending application, filed 2004 Feb. 27.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to power transmission, specifically an improved mechanical transmission that continuously varies the ratio of input to output torque and speed.

### BACKGROUND—DISCUSSION OF PRIOR ART

The prior art in continuously variable transmissions (CVTs) can be grouped into electrical, hydraulic, traction, and ratcheting categories. Electrical CVTs convert mechanical energy to electrical energy and then back to mechanical energy. Hydraulic CVTs convert mechanical energy to fluid pressure and flow and then back to mechanical energy. Substantial energy is dissipated in each of these conversions. It is desirable to have a purely mechanical device that would avoid such power loss. Many efforts have been made in this regard. Prior art CVTs other than electrical or hydraulic can be grouped into two main categories: traction drive or ratcheting. Each of these has its drawbacks.

One example of a traction drive uses a belt and variable pulleys. Another uses a split toroid and tilting rollers. All depend on shear friction on a contact patch. The ratio changes as the contact patch is moved. As the drive member always has some finite width, it will be driving a range of values across the contact patch. This is known as “spin.” There is also “slip” that occurs when the driven member falls behind the driving member due to the torque it is transmitting. Slip dissipates additional energy. Traction CVTs may have a pump to control clamping forces on the friction surfaces. More energy is consumed by the pump and does not get to the transmission output.

Ratcheting CVTs use eccentric motion and multiple power paths that are combined into the output. Each of these separate paths has a portion its motion that it is at the appropriate ratio to be locked to the output. For the portion of the motion for which the ratio is not matched, that path must be disconnected while another paths carries the load.

The device used to accomplish this function in U.S. Pat. No. 5,334,115 is the commutator. It has only discrete positions for which it works well due to teeth being used for mechanical communication. It is inherently unable to provide a continuous range of operation. For a finite set of gear ratios the teeth line up. For all other gear ratios, there is slip until the teeth line up. Another CVT that uses separated power paths is shown in U.S. Pat. No. 4,765,195. Exponential gears that are varied in phase relative to each other provide portions of a revolution of a shaft with the desired output speed. Here, one-way clutches are used to combine the power onto the output shaft and to disengage the shafts at the times they are not turning at the right speed. A lever type CVT as shown in U.S. Pat. No. 5,440,945 also has one-way clutches.

Many prior art ratcheting CVTs use one-way clutch mechanisms to recombine the power prior to output. The one-way clutches that are used in CVTs described above and many other designs have several serious drawbacks. The first is that the transmission can only transmit power in one direction. Mechanical communication is only in one direction. A one-way clutch overruns and is not able to provide functions such as engine braking. Benefits such as recovering energy during braking, or regenerative braking, cannot be realized. The reverse gear requires additional hardware.

A second drawback is that the friction that makes most one-way clutches work also causes wear, and the clutches are heavily used and have a small contact area. The clutches lock while under load. They are not synchronized. This causes slippage and additional wear. Ratchets also lock while under load, adding shock loads to the transmission. They also only lock at discrete locations, thus keeping the transmission from being truly continuously variable.

A third less obvious, but important drawback is that one way clutches can only choose the power path that is turning the fastest. In order to make use of the full range of ratios, some transmission designs require that the slower path be used for a range of ratios. In the case of a noncircular geared continuously variable transmission, being able to use the slower moving of the multiple power paths of the transmission gives it a much greater ratio range than an equivalent transmission with one way clutches.

Eccentric ratcheting CVTs are not smooth, rather they have an uneven ratio across a rotational cycle. Although the output is desired to be linearly related to the input, the speed of the output is modulated by the underlying nonlinear relationship that causes the varying ratio. This is apparent in U.S. Pat. No. 5,334,115. This is only partially solved by increasing the number of parallel power paths. Additional parallel power paths also lead to increased parts counts with higher weight and costs. A transmission design that provides a linear relationship on each power path will lead to fewer power paths with lower cost and higher efficiency.

### OBJECTS AND ADVANTAGES

Accordingly, several objects and advantages of the present invention are:
(a) to provide a mechanical continuously variable transmission that provides two way mechanical communication
(b) to provide a mechanical continuously variable transmission that has linear ratios throughout the entire power cycle
(c) to provide a mechanical continuously variable transmission that transfers power without “slip” or “spin”, thus increasing durability and decreasing unnecessary friction and heat generation
(d) to provide a mechanical continuously variable transmission in which shifting is self powered and does not require outside energy such as hydraulic or pneumatic pressure from a pump nor electric energy
(e) to provide a mechanical continuously variable transmission that does not require outside control such as computer control or active operator control
(f) to provide a mechanical continuously variable transmission that has low frictional losses
(g) to provide a mechanical continuously variable transmission that support high torque loads.

Further objects and advantages will become apparent from a consideration of the ensuing description and drawings.

### DESCRIPTION OF DRAWINGS

FIG. 1 shows an overall view of the synchronized CVT

FIG. 2 shows a top view of the synchronized CVT with the covers removed

FIG. 3 shows the relative positions of the parts in the synchronized CVT

FIG. 4 shows an overall view of a two stage synchronized CVT

FIG. 5 shows a bottom view of the two stage synchronized CVT

FIG. 6 shows the relative positions of the parts in the two stage synchronized CVT

FIG. 7 shows the shifter pawl mechanism

FIG. 8 shows the details of combination roller gear 170

FIG. 9 shows details of the control cams, arms, and bands of the clutch mechanism

FIG. 10 show the torque on I beam 141 of the synchronized CVT through several cycles

FIG. 11 shows the effective ratio of roller gear compared to the cam gear

FIG. 12 shows clutched exponential roller gear 168 and interacting exponential cam 104

FIG. 13 shows the fixed structure described below less cover 126 and cover 131

FIG. 14 shows drum axle 103 and drum 102

FIG. 15 shows clutched exponential roller gear 168

FIG. 16 shows clutched exponential roller gear 169

FIG. 17 shows exponential cam 104, exponential cam 105, and hub 142

FIG. 18 shows exponential cam 195, exponential cam 196, and hub 147

FIG. 19 shows constant cam 11a, constant cam 111b, and hub 182

FIG. 20 shows constant roller gear 172 and axle 176

### DRAWINGS—REFERENCE NUMERALS

101 guide
102 drum
103 drum axle
104 exponential cam
105 exponential cam
106 translating axle
108a roller
108b roller
108c roller
108d roller
108e roller
108f roller
108g roller
108h roller
109 shift cam
110 axle
111 constant cam
114a band
114b band
116 track
118 hub
119 clamp
120 counterweight
121 arm
122 plate
123 plate
124 bearing
125 gear
126 end cover
127 plate
128 plate
129 end cover
130 plate
131 cover
133 bracket
134 bracket
135 bracket
136 follower axle
137a cam follower
137b cam follower
138 axle support
139 bracket
140 bracket
141 I beam
142 hub
143 key
144 key
145 key
146 key
147 hub
148 disk
149 disk
150 retainer
151 bracket tip
152 arm
153 lever
154 handle
155 hub
156a pawl
156b pawl
157 pawl axle
159 pivot
160 hub
161 disk
162 disk
163 disk
164 disk
165 disk
166 disk
167 disk
168 clutched exponential roller gear
169 clutched exponential roller gear
170 combination roller gear
171 shift roller gear
172 constant roller gear
173 disk
174 disk
175 bracket
176 axle
177 selector inner arm
178 selector outer arm
179 selector tube
180 axle
181 retainer
182 hub
183 spacer
184 hub
185 washer
186 washer
187 washer
188 washer
189 washer
190 washer
191 washer
192 control cam
193 control cam
194 control cam
195 exponential cam
196 exponential cam
197 shift cable
198 shift cable
199 support wheel
200 spring
201 support axle
301 guide
302 drum
303 drum axle
304 exponential cam
305 exponential cam
306 translating axle
308a roller
308b roller
308c roller
308d roller
308e roller
308f roller
308g roller
308h roller
309 shift cam
310 axle
311 constant cam
312 washer
313 washer
314a band
314b band
315 pin
317 block
318 hub
319 clamp
320 counterweight
321 arm
322 structure
323 structure
324 bearing
325 gear
326 end cover
327 plate
328 plate
329 end cover
330 plate
331 cover
333 bracket
334 bracket
335 bracket
336 follower axle
337a cam follower
337b cam follower
338 axle support
339 bracket
340 bracket
341 I beam
342 hub
347 hub
348 disk
349 disk
350 retainer
351 bracket tip
352 arm
353 lever
354 handle
355 hub
356a pawl
356b pawl
357 pawl axle
358 pin
359 pivot
360 hub
361 disk
362 disk
363 disk
364 disk
365 disk
366 disk
367 disk
368 clutched exponential roller gear
369 clutched exponential roller gear
370 combination roller gear
371 shift roller gear
372 constant roller gear
373 disk
374 disk
375 bracket
376 axle
377 selector inner arm
378 selector outer arm
379 selector tube
380 axle
381 retainer
382 hub
383 spacer
384 hub
392 control cam
393 control cam
394 control cam
395 exponential cam
396 exponential cam
397 shift cable
398 shift cable
399 support wheel
401 support axle
506 translating axle
522 plate
523 plate
532 cover
523a slot in cover
595 car
596 axle

### DESCRIPTION OF INVENTION

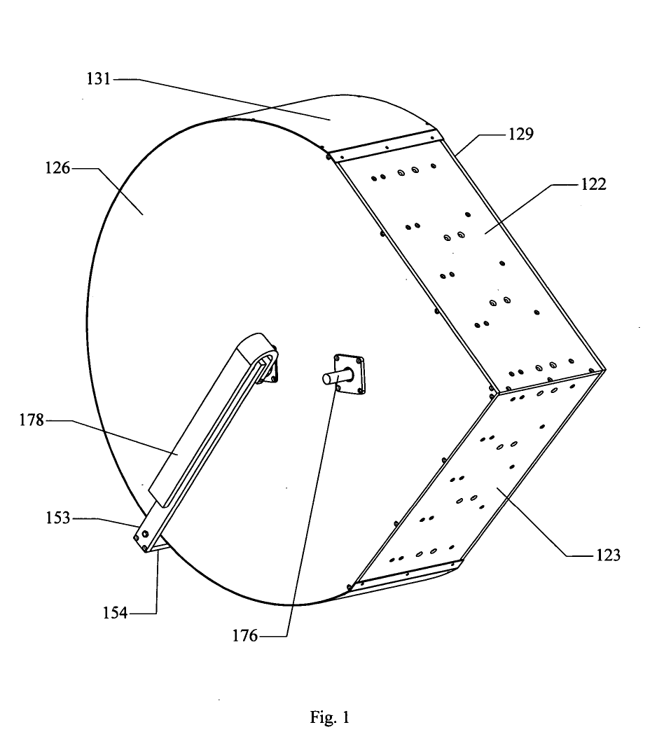

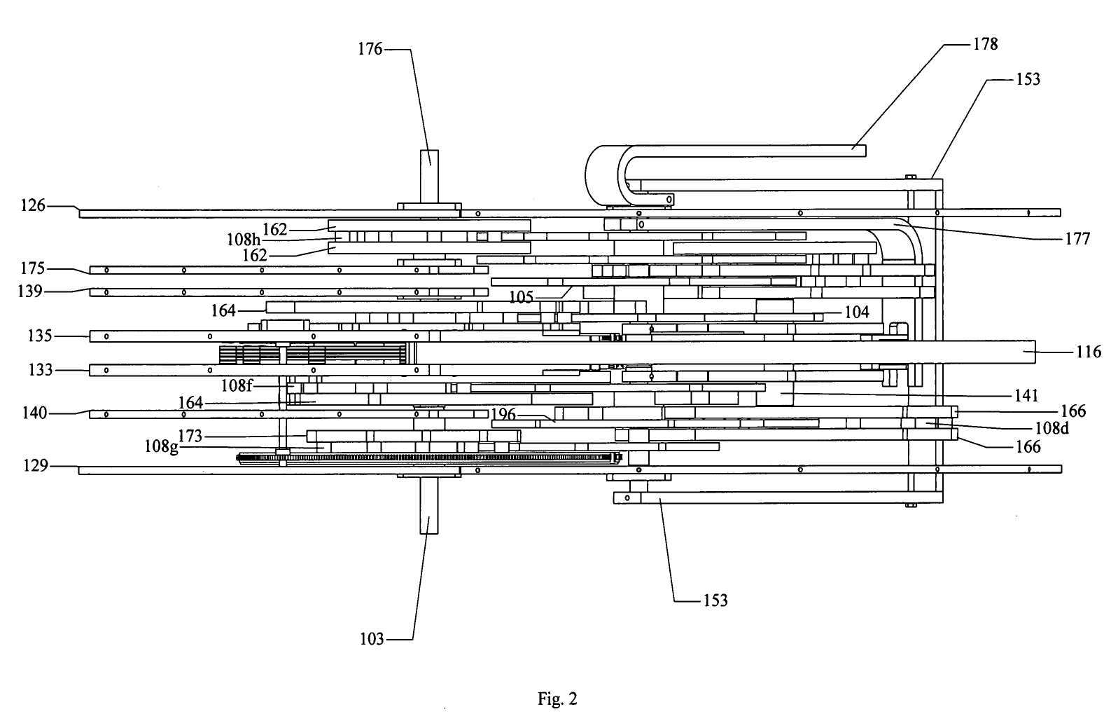

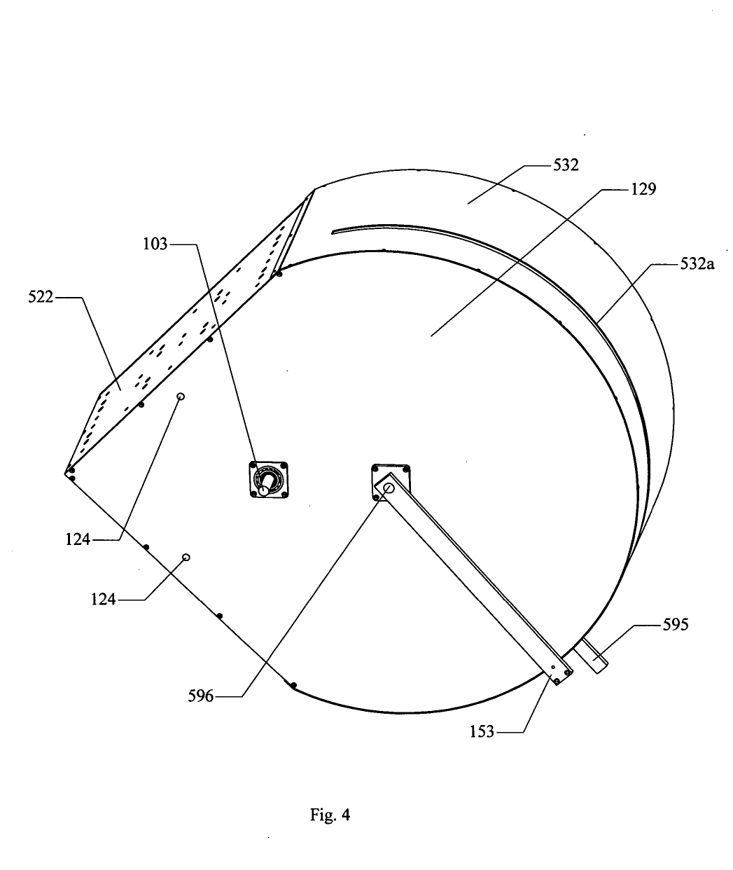

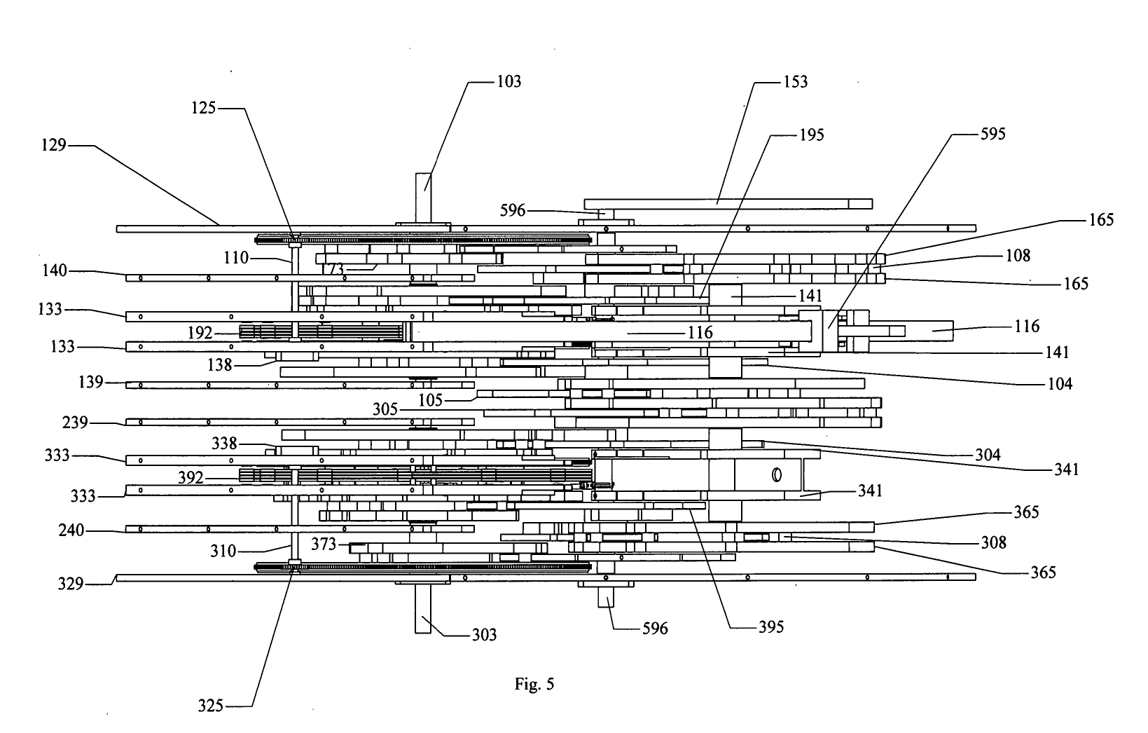

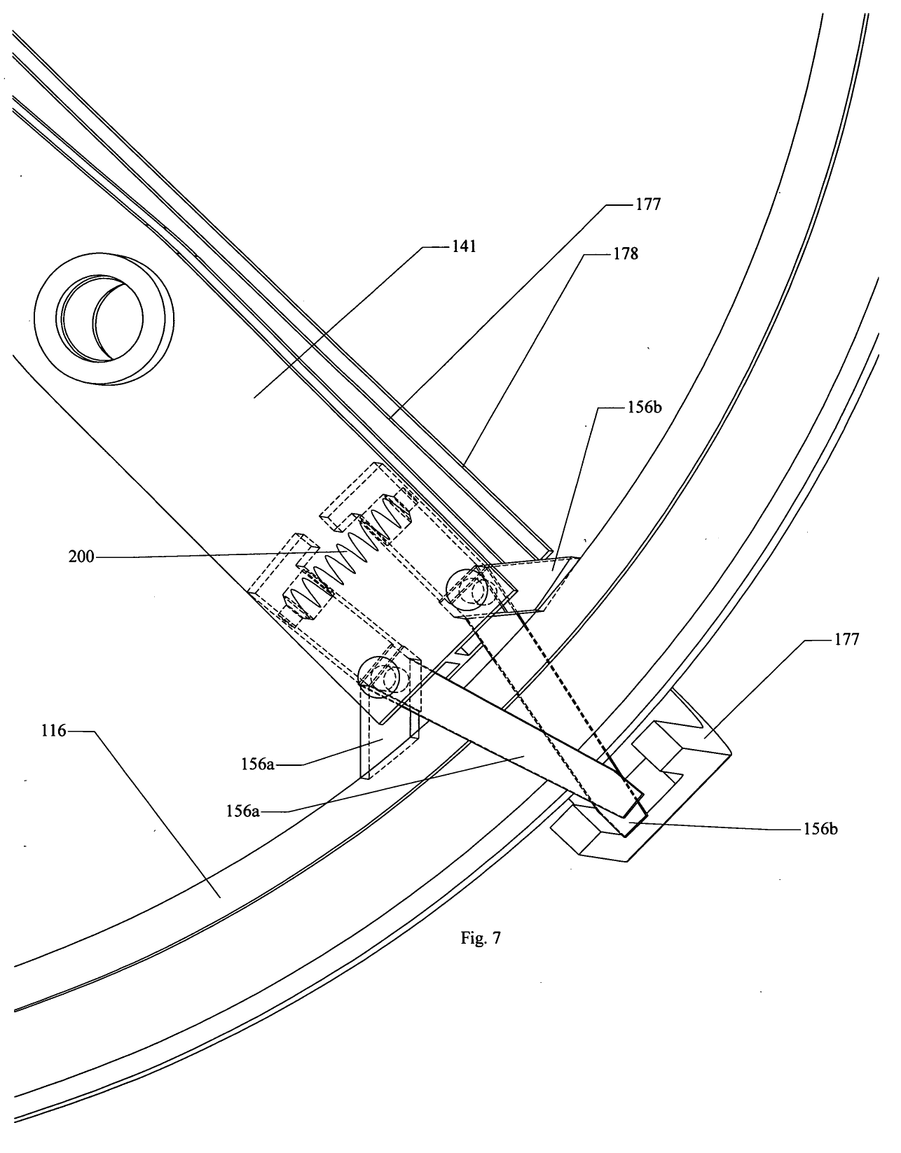

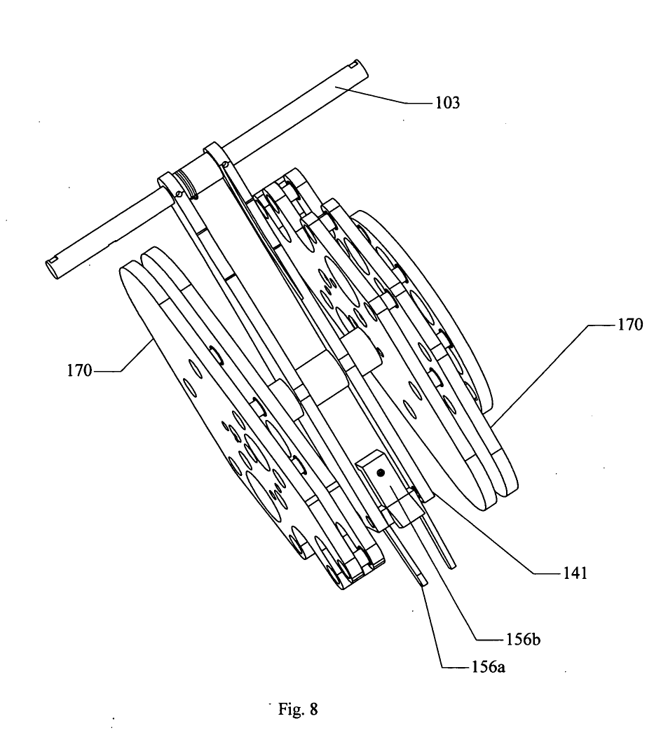

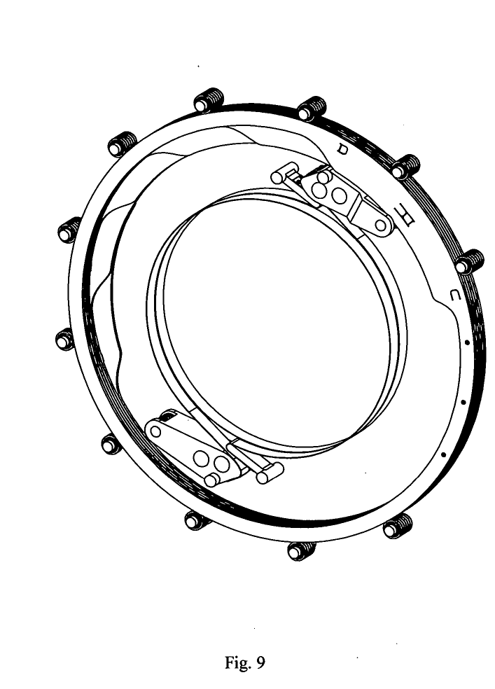

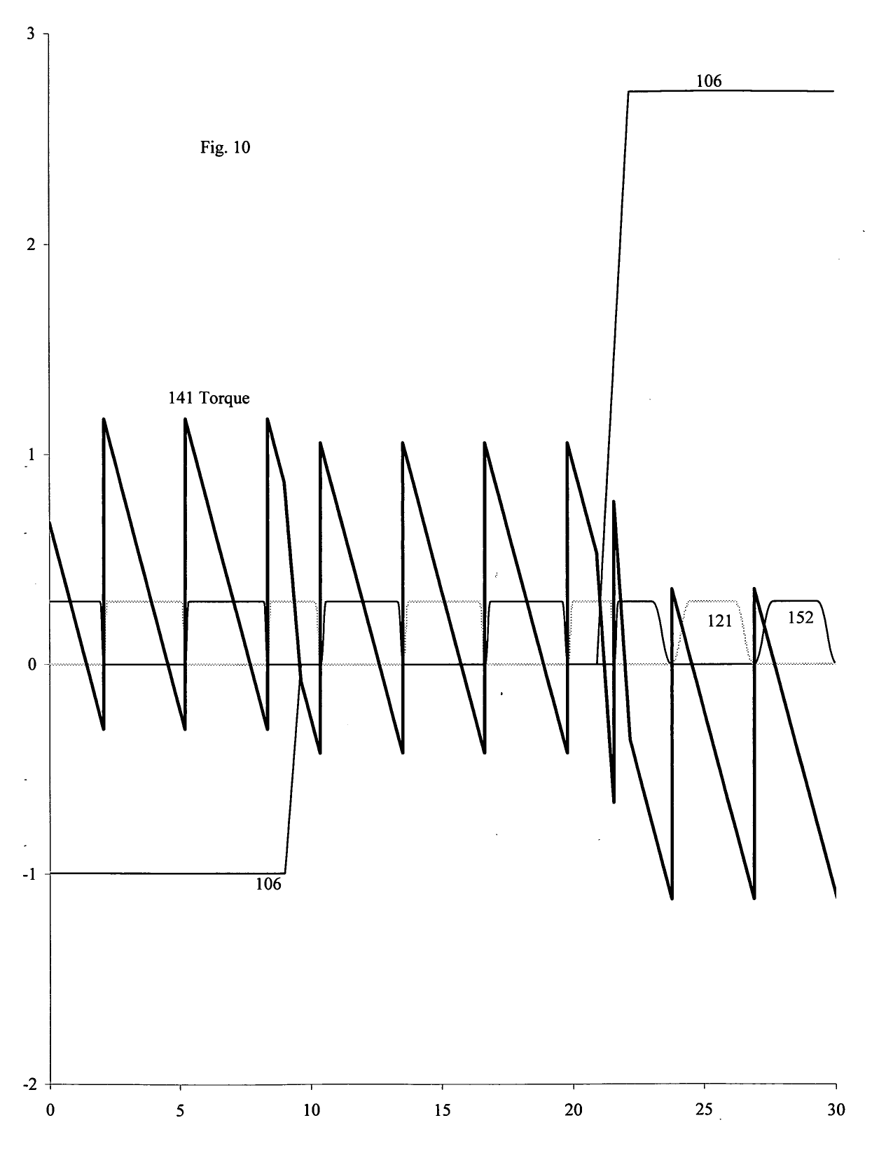

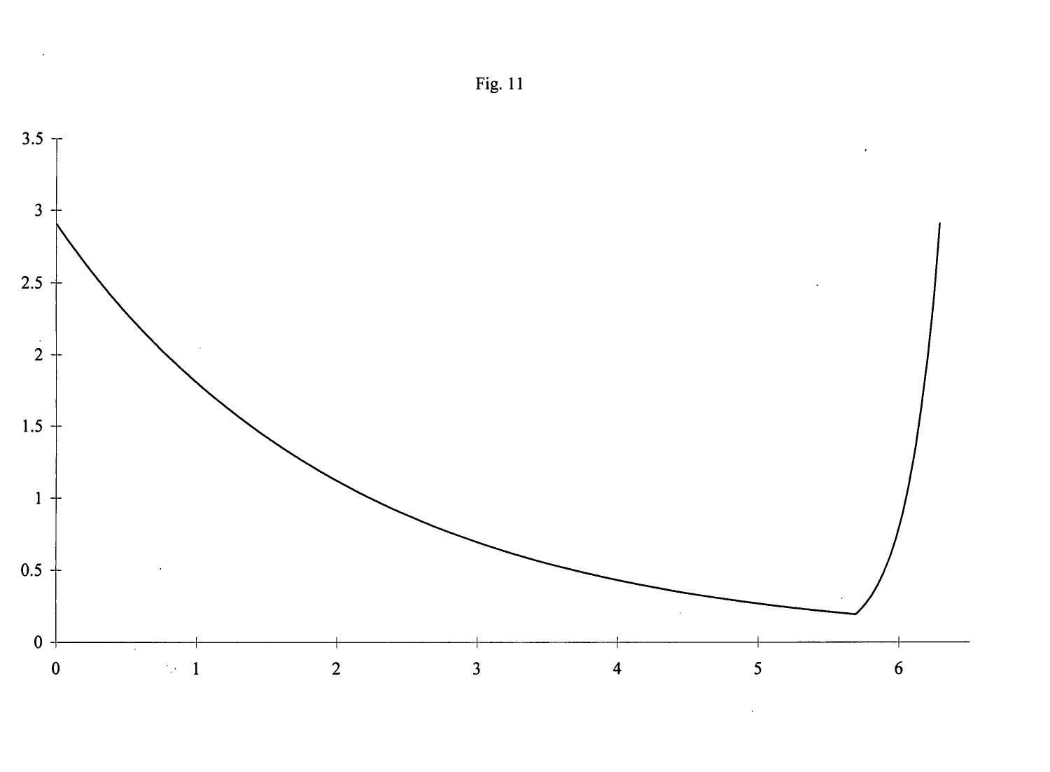

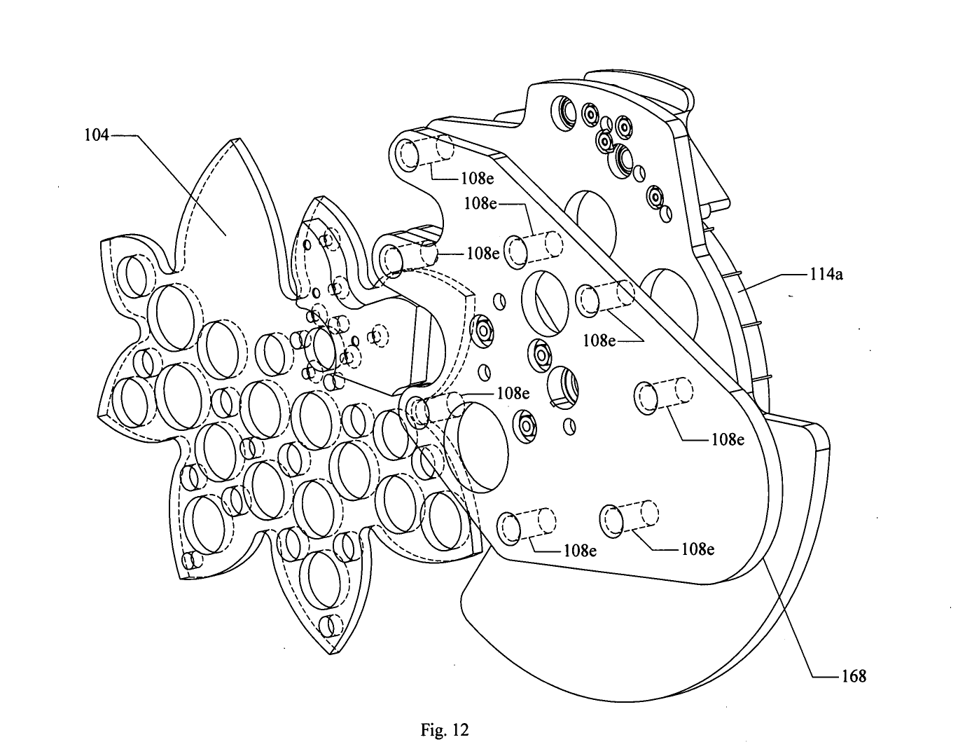

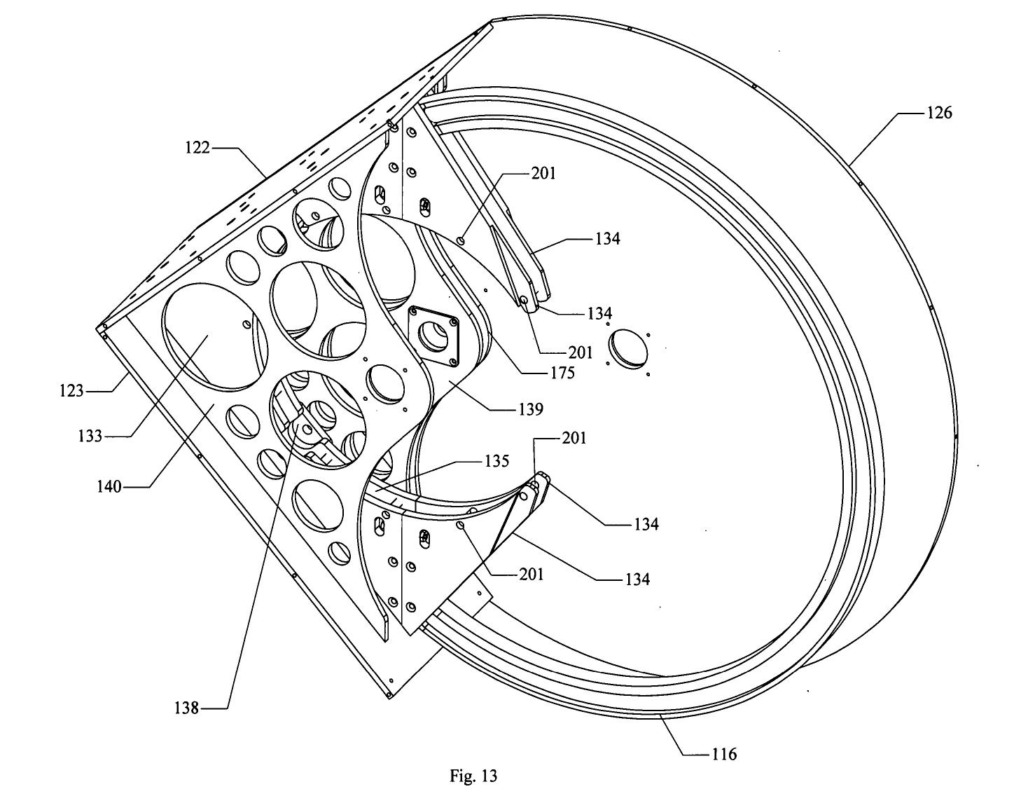

FIG. 1 through FIG. 3, FIG. 8, FIG. 10, and FIG. 13 describe an embodiment of the synchronized mechanical CVT. FIG. 4 through FIG. 6 describe an embodiment of a two stage synchronized mechanical CVT. FIG. 7, FIG. 9, FIG. 11, and FIG. 12 show components and relationships that are common to both embodiments.

FIG. 13 shows the fixed structure described below less cover 126 and cover 131 that are removed to show the rest of the structure. FIG. 1 shows cover 126 and 131 in place. The foundation of the main structure of the synchronized mechanical CVT is plate 122 and plate 123. Cover 126 and cover 129 are fastened to their sides. Cover 131 wraps around covers 126 and 129 and also fastens to plates 122 and 123. The rotating power handling parts that do not translate are supported by bearings held by bracket 139, bracket 140, bracket 175, cover 126, and cover 129. The rotating power handling parts that do translate, specifically those in combination roller gear 170, are supported by bearings held by I beam 141. I beam 141 is supported by bearings held by cover 126 and cover 129. The rotating parts that do not handle power are support by bracket 133, brackets 134, bracket 135, axle supports 138, and cover 129.

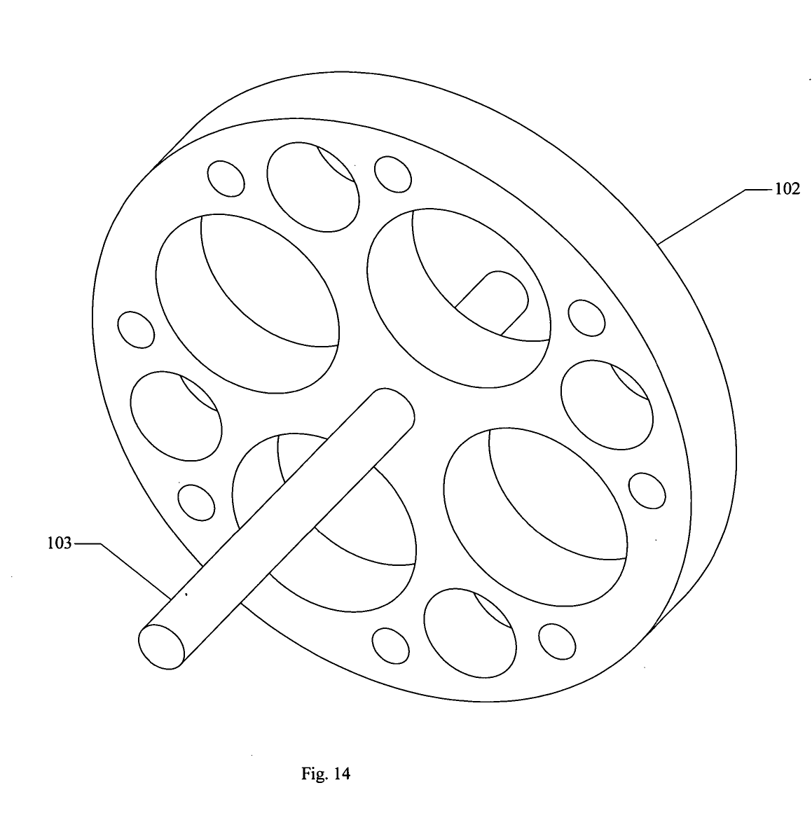

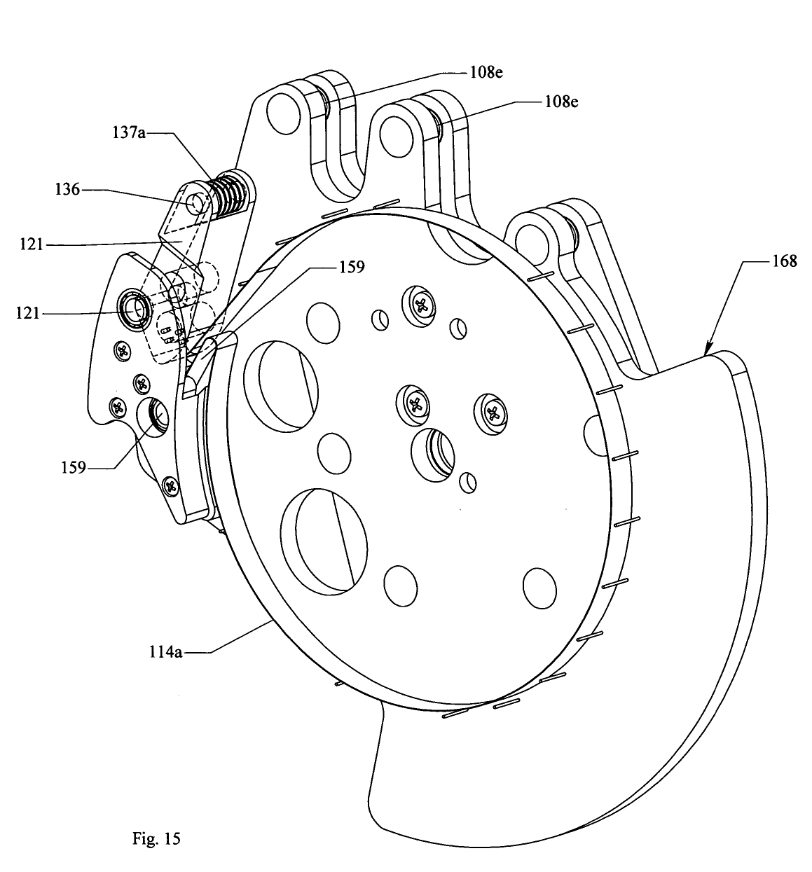

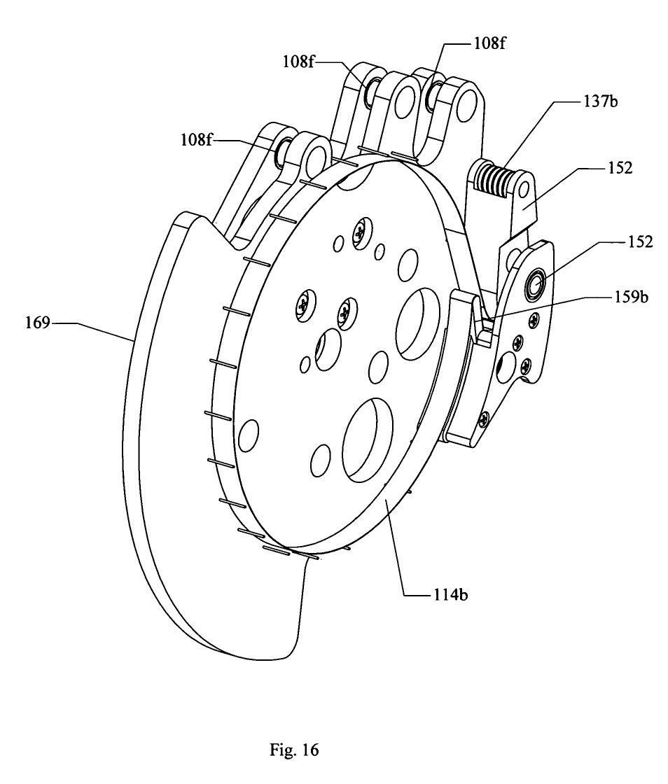

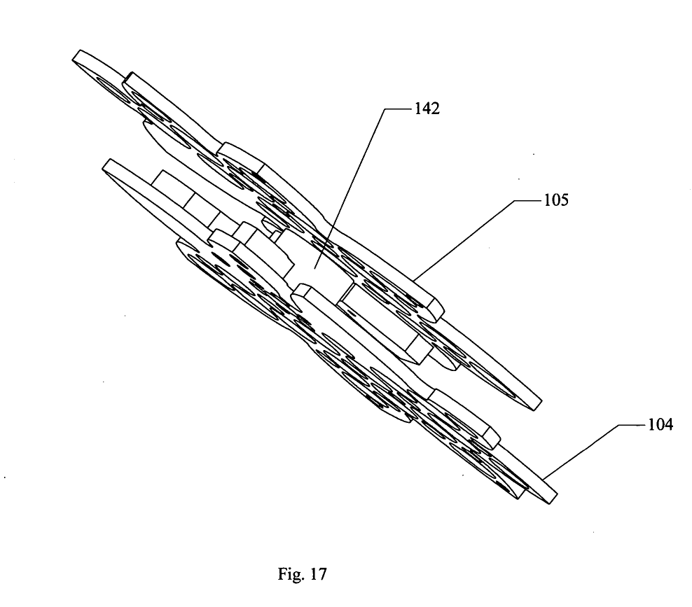

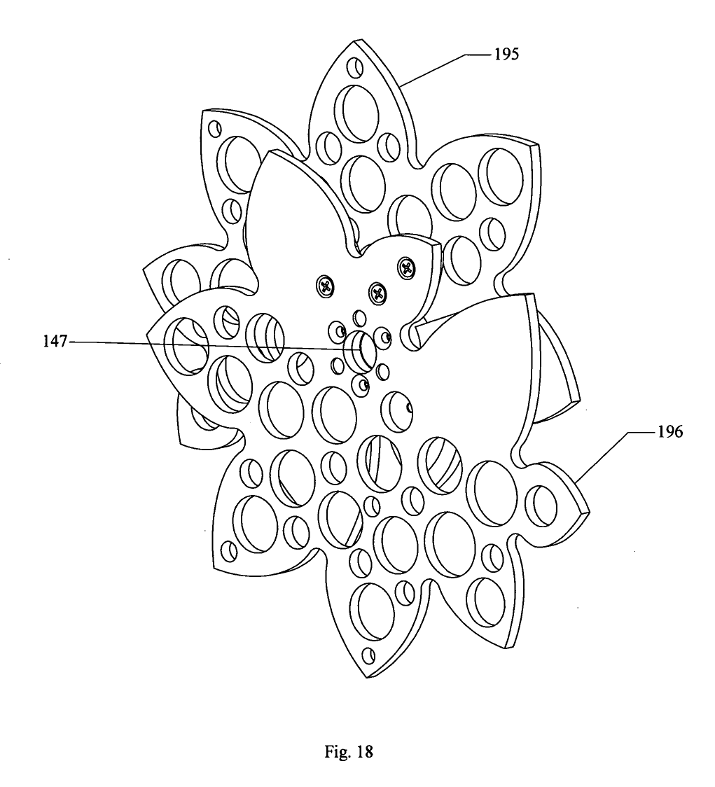

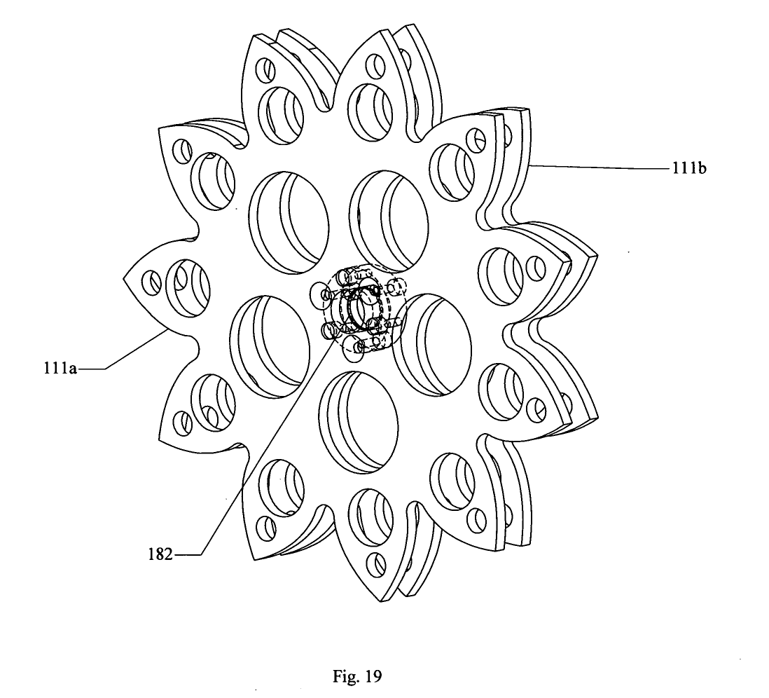

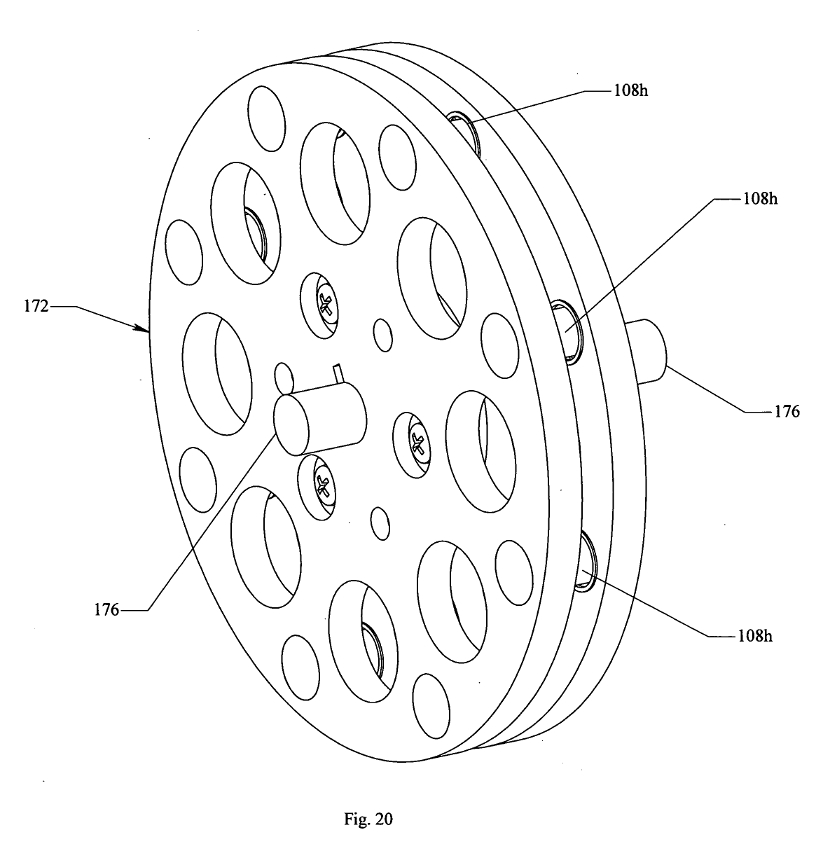

The rotating power handling parts that do not translate are shown in FIG. 12, FIG. 14, FIG. 15, FIG. 16, FIG. 17, FIG. 18, FIG. 19, and FIG. 20. They are drum axle 103, drum 102, exponential cam 104, hub 142, exponential cam 105, exponential cam 195, hub 147, exponential cam 196, constant cam 11a, hub 182, constant cam 111b, band 114a, band 114b, arm 121, arm 152, pivot 159a, pivot 159b, clutched exponential roller gear 168, clutched exponential roller gear 169, constant roller gear 172, axle 176.

The rotating power handling parts that translate are shown in FIG. 8.

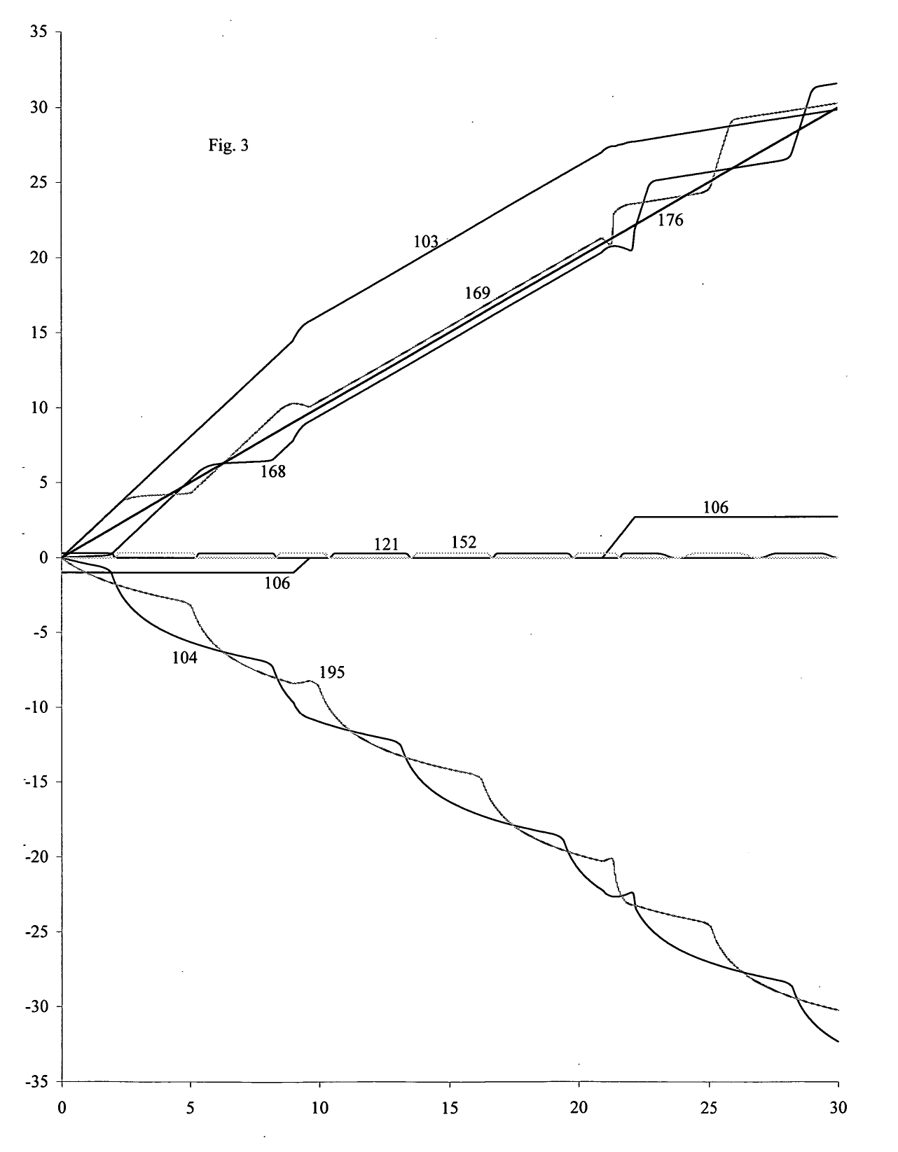

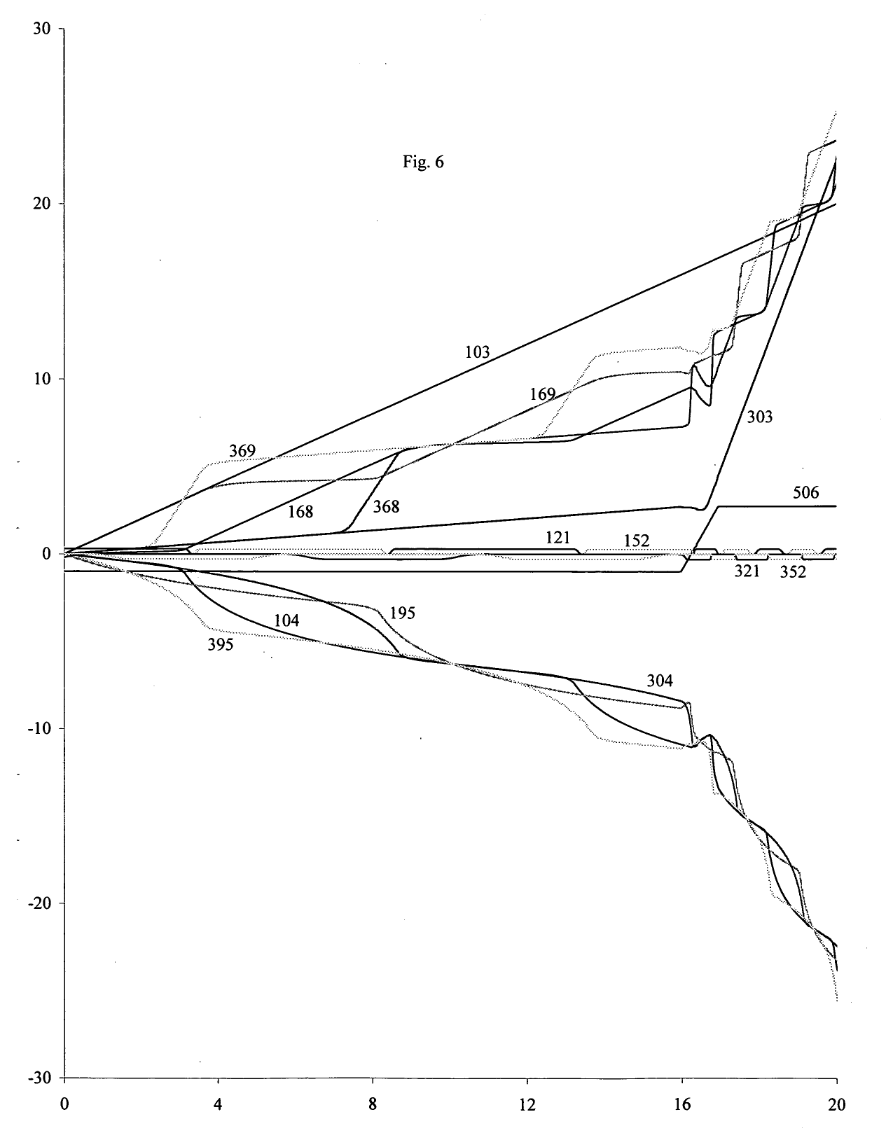

FIG. 6 shows the angular position of several of the main parts of the two stage synchronized mechanical CVT. It is formed by using two synchronized mechanical CVTs which are joined by sharing translating axle 506 and axle 508 in what had been translating axles 106 and axles 108 in each of the individual synchronized mechanical CVT prior to their being joined. The first CVT is the same as the one in FIG. 3 less some parts that are used to get the power from translating axle 106 to flow from a fixed location. The second CVT is also the same as the one in FIG. 3 less the same parts as the first CVT and also less the pawl mechanism that is redundant with the pawl mechanism of the first CVT. Car 595 on track 116 takes the place of selector inner arm 177, selector outer arm 178, and selector tube 179 from both CVTs. The second CVT is flipped over so that what had been its front view is now facing back and what had been its top view is now facing down. Parts from the first synchronized CVT are numbered from 101 to 299. Parts from the second synchronized CVT are numbered from 301 to 499. Shared parts are numbered from 501 to 699.

### OPERATION OF INVENTION

FIG. 3 shows the angular position of several of the main parts of the synchronized mechanical CVT. All other parts shown are referenced to the position of axle 176. If axle 176 is considered the input, then drum axle 103 is acting as the output. Due to the clutches holding both forward and backward, the input and output could be reversed. Let the power flow through parts 168, 104, 105, and 170 be called Path A. Likewise, let the power flow through parts 169, 195, 196, and 171 be called Path B. Either Path A of Path B will be used at all times.

Axle 176 is fastened to and turns with constant roller gear 172. Rollers 108h on constant roller gear 172 turns the first constant cam 11a. It is fastened to and turns with a second constant cam 111b. The second constant cam 111b turns combination roller gear 170 by pushing on rollers 108a. The power flow splits here.

For Path A, rollers 108b on combination roller gear 170 turn exponential cam 105. Exponential cam 105 is fastened to and turns with exponential cam 104. Exponential cam 104 turns clutched exponential roller gear 168 by pushing on rollers 108e. Cam followers 137a on arm 121 roll along control cams 192, 193, and 194 and pivot arm 121 as they do. Band 114a on clutched exponential roller gear 168 is pulled against drum 102 by arm 121 when cam followers 137a roll along the portions of control cams 192, 193, and 194 that are at a smaller radius. Band 114a is released when cam followers 137a on arm 121 pass over the sections that are at the larger radius. This release is indicated in FIG. 3 by the line labeled 121 becoming positive. Band 114a turns drum 102. Drum 102 is fastened to and turns with drum axle 103.

For Path B, rollers 108d on combination roller gear 170 turn exponential cam 196. Exponential cam 196 is fastened to and turns with exponential cam 195. Exponential cam 195 turns clutched exponential roller gear 169 by pushing on rollers 108f. Cam followers 137b on arm 152 roll along control cams 192, 193, and 194 and pivot arm 152 as they do. Band 114b on clutched exponential roller gear 168 is pulled against drum 102 by arm 121 when cam followers 137b roll along the portions of control cams 192, 193, and 194 that are at a smaller radius. Band 114b is released when cam followers 137b on arm 152 pass over the sections that are at the larger radius. This release is indicated in FIG. 3 by the line labeled 152 becoming positive. Band 114b turns drum 102. Drum 102 is fastened to and turns with drum axle 103.

Path A and Path B are alternatively selected by the interaction of control cams 192, 193, and 194 and cam followers 137a and 137b. Control cams 192, 193, and 194 are held in position by multiple support wheels 199 turning on support axles 138. The support axles are held by brackets 133, 134, and 135. The position of control cam 193 is driven by I beam 141. Cable 197 and cable 198 wrap around I beam 141, one in each direction. The ends are fastened to guide 101. Guide 101 is fastened to and turns with control cam 193. When I beam 141 is turned in a positive direction, control cam 193 turns in a negative direction. Likewise, control cam 194 is driven by I beam 141, though in a nonlinear relationship. Shift cam 109 is fixed on translating axle 106 as is I beam 141. Shift cam 109 turns shift roller gear 171 by pushing on rollers 108g. Shift roller gear 171 turns gears 125a on axles 110 supported by bearings 124. Gears 125b are fastened on and turn with axles 110. Gears 125b turn control cam 194. When I beam 141 is turned in a positive direction, control cam 194 turns in a negative direction faster than control cam 193. Thus control cam 193 and control cam 194 are lined up when I beam 141 is turned to its highest positive position and separated when I beam is turned to its most negative position. Positive is measured in a clockwise direction when looking at the front view. Additional control cams are inserted between control cam 193 and control cam 194 to ensure the raised portion is continuous when control cams 193 and 194 are separate but allowing a shorter raised portion when control cams 193 and 194 are lined up. Tabs 192a interact each other and with tabs 193a and tabs 194a to keep control cams 192 from overrunning control cams 193 and 194. The relationship of I beam 141 position and control cams 192, 193, and 194 is shown in FIG. 11.

I beam 141 can be moved directly by an outside force. When the CVT is transmitting torque, there is torque on I beam 141 as a result of the differing effective gear ratios acting on combination roller gear 170. The torque on I beam 141 plotted against the motion of drum axle 103 is shown in FIG. 10. Proper selection of the ratio of between constant cam 111b and combination roller gear 170 will provide torque on I beam that alternates from positive to negative as the parts rotate. Both positive torque and negative torque occur in all ratios across the available range as shown in FIG. 10. This torque can be used to rotate I beam 141 to a desired position. In this embodiment, pawls 156a and 156b hold the end of I beam against track 116 as seen in FIG. 7. They are controlled by selector inner arm 177. Selector inner arm 177 is fastened to and turns with selector tube 179. Selector tub 179 is fastened to and turns with selector outer arm 178. A low torque outside control force applied to selector outer arm 178 in a positive direction will contact the lever arm of pawl 156a and release pawl 156a from track 116. As the torque on I beam becomes positive, it will move it in a positive direction until the lever arm of pawl 156a moves away from selector inner arm 177. Though not shown is this embodiment, the low torque control force could be spring loaded such that it could be set to its final position and selector outer arm would then move to the desired position when the torque on I beam 141 was sufficient some time later.

The position of I beam 141 and thus translating axle 106 controls the ratio of the CVT. The exponential relationship of combination roller gear 170 to exponential cams 105 and 106 is inverted by the exponential relationship of clutched exponential roller gears 168 and 169, providing a constant ratio at any one angle that can be varied by changing the angle of I beam 141. The clutching mechanism of bands 114a and 114b on drum 102 ensures that one of Path A or Path B are enabled. When power is flowing in Path A, the parts of Path B are kept synchronized by combination roller gear 170. Likewise, when power is flowing in Path B, the parts of Path A are kept synchronized by combination roller gear 170. Path A begins to be released as soon as Path B is fully enable and Path B begins to be released as soon as Path A is fully enable. Movement of I beam 141 is enhanced by having only one of Path A or Path B in use at a time. This allows movement of the unused path as I beam 141 is moved.

The motion of the parts of the two stage mechanical CVT is described by FIG. 6. In FIG. 6, all parts shown are referenced to the position of drum axle 103. If drum axle 103 is considered the input, then drum axle 303 is acting as the output. Due to the clutches holding both forward and backward, the input and output could be reversed. Let the power flow through parts 114a, 168, 104, 105, and 170 be called Path 1. Let the power flow through parts 114b, 169, 195, 196, and 171 be called Path 2. Let the power flow through parts 314a, 368, 304, 305, and 370 be called Path 3. Likewise, let the power flow through parts 314b, 369, 395, 396, and 371 be called Path 4. Either Path 1 or Path 2 will be used at all times.

Likewise, either Path 3 or Path 4 will be used at all times. The power flow is determined at drum 102 and drum 302. Clutched exponential roller gear 168 and clutched exponential roller gear 169 are alternatively driven by drum axle 103 through drum 102 depending on their position relative to control cams 192, 193, and 194. Clutched exponential roller gear 368 and clutched exponential roller gear 369 alternatively drive drum axle 303 through drum 302 depending on their position relative to control cams 392, 393, and 394.

Path 1 flows through band 114a. Band 114a is tightened as the rollers on arm 121 pass over the raised sections of control cams 192, 193, and 194. Band 114a is released when the rollers on arm 121 pass over the sections that are at the larger radius. This release is indicated in FIG. 7 by the line labeled 121 becoming positive. Clutched exponential roller gear 168 is driven by drum axle 103 through drum 102. Clutched exponential roller gear 168 turns exponential cam 104 by pushing on it with rollers 108e. Exponential cam 104 and exponential cam 105 turn together on the same hub. Exponential cam 105 turns combination roller gear 570 by pushing on rollers 108b.

Path 2 flows through band 114b. Band 114b is tightened as the rollers on arm 152 pass over the raised sections of control cams 192, 193, and 194. Band 114b is released when the rollers on arm 152 pass over the sections that are at the larger radius. This release is indicated in FIG. 7 by the line labeled 152 becoming positive. Clutched exponential roller gear 169 is driven by drum axle 103 through drum 102. Clutched exponential roller gear 169 turns exponential cam 195 by pushing on it with rollers 108f. Exponential cam 195 and exponential cam 196 turn together on the same hub. Exponential cam 196 turns combination roller gear 570 by pushing on rollers 108d.

When power is flowing in Path 1, the parts of Path 2 are kept synchronized by translating axle 506.

Path 3 flows through band 314a. Band 314a is tightened as the rollers on arm 321 pass over the raised sections of control cams 392, 393, and 394. Band 314a is released when the rollers on arm 321 pass over the sections that are at the larger radius. This release is indicated in FIG. 7 by the line labeled 321 becoming negative. Combination roller gear 570 turns exponential cam 305 with rollers 308b. Exponential cam 305 and exponential cam 304 turn together on the same hub. Exponential cam 304 turns clutched exponential roller gear 368 by pushing on rollers 308e. Clutched exponential roller gear 368 drives drum axle 303 through drum 302.

Path 4 flows through band 314b. Band 314b is tightened as the rollers on arm 352 pass over the raised sections of control cams 392, 393, and 394. Band 314b is released when the rollers on arm 352 pass over the sections that are at the larger radius. This release is indicated in FIG. 7 by the line labeled 352 becoming negative. Combination roller gear 570 turns exponential cam 396 with rollers 308d. Exponential cam 396 and exponential cam 395 turn together on the same hub. Exponential cam 395 turns clutched exponential roller gear 369 by pushing on rollers 308f. Clutched exponential roller gear 369 drives drum axle 303 through drum 302.

The position of I beam 141 in the two stage synchronized CVT is controlled by pawls 156a and 156b that are controlled by car 595. Car 595 can be accessed through slot 532a in cover 532 as shown in FIG. 4. The position of I beam 141 could also be controlled directly.

### SUMMARY, RAMIFICATIONS, AND SCOPE

Accordingly, the reader will see that the synchronized mechanical continuously variable transmission of this invention transmits high and low torque and power efficiently across a wide range of input to output ratios in a linear relationship while using its own power for shifting. In addition, it supports torque and motion both forward and backward with low wear and simple control.

Although the description above contains many specificities, these should not be construed as limiting the scope of the invention but as merely providing illustrations of some of the presently preferred embodiments of this invention. For example, the clutch is shown as a band but may have other forms such as a disk. Thus the scope of the invention should be determined by the appended claims and their legal equivalents, rather than by the examples given.

1. A continuously variable transmission comprising:
a plurality of varying ratio rotary transmission means turning on an axis imparting rotary motion to a second plurality of rotary transmission means turning on a second axis with some portion of the first combined ratio varying exponentially, said second plurality of rotary transmission means driving a third plurality of rotary transmission means turning on a third axis with some portion of the second combined ratio varying in an inversely exponential relation to said first ratio, one of said first, second, or third axes translated relative to the others changing the overall ratio of said transmission, the output of said plurality of third inverse rotary transmission means combined using a plurality of synchronized dual directionally locking clutching means, said transmission providing rotary motion about the said first axis that is linearly related to rotary motion about said third axis, the overall linear ratio depending on the relative translation of said first, second, and third axes.

2. A stepless transmission comprising a plurality of angular velocity modulating devices each comprising a primary angular velocity modulating means composed of a first non-circular gear fixedly mounted on a first rotary shaft and a second non-circular gear fixedly mounted on a second rotary shaft and meshed with said first non-circular gear for determining a primary angular velocity ratio as an angular velocity ratio of said second rotary shaft to said first rotary shaft, a secondary angular velocity modulating means composed of said first non-circular gear and a third non-circular gear supported on a third rotary shaft such that power is transmitted to said third rotary shaft, said third non-circular gear being meshed with said first non-circular gear, said secondary angular velocity modulating means functioning to determine a secondary angular velocity ratio as an angular velocity ratio of said third rotary shaft to said first rotary shaft, a first frame for supporting said first rotary shaft and said second rotary shaft through bearings, respectively, and a second frame for supporting said third rotary shaft through bearings, said second frame being supported by said first rotary shaft rotatably about said first rotary shaft with respect to said first frame, some portion of said primary angular velocity ratio being expressed by an exponential function, whereby an angular velocity ratio of said third rotary shaft to said second rotary shaft is obtained as a result of division of said secondary angular velocity ratio by said primary angular velocity ratio, said angular velocity modulating devices being combined using a clutching means to provide a constant ratio overall for each said relative rotational amount between said first frame and said second frame, said clutching means supporting rotary effort in both directions and selecting a plurality of said angular velocity modulating devices with said angular velocity ratio at the desired value.

3. The transmission as claimed in claim 1, wherein said exponential and said inverse exponential ratios are provided via roller gear and cam gear transmission means.

4. The transmission as claimed in claim 2, wherein said angular velocity modulation means are provided via roller gear and cam gear angular velocity modulating means.

5. The transmission as claimed in claim 1, wherein said plurality of synchronized dual directionally locking clutching means are provided via band clutches on a drum.

6. The transmission as claimed in claim 2, wherein said clutching means is provided via band clutches on a drum.

7. A multiple stage continuously variable transmission comprising:
a first transmission as claimed in claim 1, mated to at least one other transmission as claimed in claim 1, said first and other transmissions mated such that the translating axis rotational means output of one is the translating axis rotational means input of the other, with overall ratios selected to be inverse such that the translation of said translating axis rotational means output and translation of said translating axis rotational means move the ratio of said first transmission in the same direction as said second transmission, whether increasing or decreasing, thus allowing the overall input to remain fixed relative to the overall output while the overall ratio is the product of said ratios of said first and said other transmissions.

8. A multiple stage stepless transmission comprising:
a first transmission as claimed in claim 2, mated to at least one other transmission as claimed in claim 2, said first and other transmissions mated such that said third rotary shaft of said first transmission is mated to said third rotary shaft of said other transmission, with said K of said first transmission set at a value that is the inverse of said K of said other transmission, such that said relative rotational amount between said first frames and said second frames moves said ratio of said first transmission in the same direction as said second transmission, whether increasing or decreasing, thus allowing the overall input to remain fixed relative to the overall output while the overall ratio is the product of said ratios of said first and said other transmissions.

9. The transmission as claimed in claim 7, wherein said exponential and said inverse exponential ratios are provided via roller gear and cam gear transmission means.

10. The transmission as claimed in claim 8, wherein said angular velocity modulation means are provided via roller gear and cam gear angular velocity modulating means.

11. The transmission as claimed in claim 7, wherein said plurality of synchronized dual directionally locking clutching means are provided via band clutches on drums.

12. The transmission as claimed in claim 8, wherein said clutching means is provided via band clutches on drums.

13. The transmission as claimed in claim 1, wherein said axis translation is controlled by a low torque ratio setting means and driven by torque internal to said transmission.

14. The transmission as claimed in claim 2, wherein said relative rotational amount between said first frames and said second frames is controlled by a low torque ratio setting means and driven by torque internal to said transmission.

15. The transmission as claimed in claim 7, wherein said axis translation is controlled by a low torque ratio setting means and driven by torque internal to said transmission.

16. The transmission as claimed in claim 8, wherein said relative rotational amount between said first frames and said second frames is controlled by a low torque ratio setting means and driven by torque internal to said transmission.
